(19) United States
(12) Patent Application Publication
(10) Pub. No.: US 2002/0183049 A1
(43) Pub. Date: Dec. 5, 2002

(54) On-vehicle communication device and a method for communicating on-vehicle

(76) Inventors: Toshihiro Yukitomo, Sagamihara-shi (JP); Naoto Furuya, Sagamihara-shi (JP)

Correspondence Address: MCDERMOTT WILL & EMERY, 600 13TH STREET, N.W., WASHINGTON, DC, 20005-3096, US

(21) Appl. No.: 10/136,449

(22) Filed: May 2, 2002

(30) Foreign Application Priority Data
May 7, 2001 (JP) 2001-136629

(51) Int. Cl. H04M 3/42; H04M 1/00; H04B 1/38

(52) U.S. Cl. 455/414; 455/550

(57) ABSTRACT

An on-vehicle communication device executes data processing to engage in data communication with an external apparatus via a wireless telephone unit, allows a telephone conversation to be conducted with the outside via the wireless telephone unit with a speech of a passenger input through a microphone and also executes voice processing for recognizing a speech of a passenger input through the microphone and converting the speech to control information. The on-vehicle communication device recognizes a speech input through the microphone during data communication, converts the recognized speech to control information and executes processing corresponding to the control information.

### BACKGROUND OF THE INVENTION

1. Field of the Invention

The present invention relates to an on-vehicle communication device and a method for communicating on vehicle.

2. Related Art

Mobile terminal devices that engage in data communication with a host computer through a wireless telephone function in the related art include the device disclosed in Japanese Laid-Open Patent Publication No. H8-186654. This mobile terminal device can be switched to a telephone mode or a terminal mode. A telephone call is made on the mobile terminal device via a public telephone network if the telephone mode is selected, whereas the mobile terminal device engages in data communication with a host computer via the public telephone network if the terminal mode is selected.

When the terminal mode is selected, the mobile terminal device establishes a communication with the host computer via a public wireless telephone network. Then, it prepares data by performing voice analysis on a voice command input through a microphone and transmits the data to the host computer as voice command data. The host computer executes command processing in conformance to the voice command data that it has received and transmits required command data to the mobile terminal device via the public wireless telephone network. The mobile terminal device synthesizes a voice based upon the command data received from the host computer and outputs the voice from a speaker.

### SUMMARY OF THE INVENTION

The mobile terminal device described above may be mounted at a vehicle as an on-vehicle communication device. In such a case, the mobile terminal device can be utilized as a wireless telephone via a mobile telephone or a car phone and can be also utilized as a mobile terminal that engages in data communication with a host computer.

However, in the mobile terminal device of the related art described above, data are prepared by performing voice analysis on the voice command input through the microphone and the data thus created are transmitted as voice command data to the host computer via the public wireless telephone network. Thus, a problem arises in that a speech cannot be input through the microphone while data communication is in progress in the terminal mode. In addition, there is a problem in that a speech cannot be input promptly if the data communication is being performed at a low data transfer speed or if a large volume of data are being transferred.

An object of the present invention is to provide an on-vehicle communication device and a method for on-vehicle communication-capable of performing speech-recognition during data communication.

An on-vehicle communication device according to the present invention comprises a wireless telephone unit that performs wireless communications, a data processing unit that engages in data communication with an external apparatus via said wireless telephone unit, a voice processing unit that receives a speech of a passenger through a microphone to allow a telephone conversation to be conducted with an outside via said wireless telephone unit and to recognize the speech of the passenger input through the microphone and convert the speech to control information and a controlling unit that engages said voice processing unit to recognize the speech input through said microphone and to convert the speech to control information and executes processing corresponding to the control information while a data communication is in progress through said data processing unit.

An on-vehicle communication device according to the present invention comprises a connection unit that is capable of being connected with a wireless telephone unit to perform wireless communications, a data processing unit that engages in data communication with an external apparatus via the wireless telephone unit, a voice processing unit that receives a speech of a passenger through a microphone to allow a telephone conversation to be conducted with an outside via the wireless telephone unit or to recognize the speech of the passenger input through the microphone and convert the speech to control information and a controlling unit that engages said voice processing unit to recognize the speech input through the microphone and to convert the speech to control information and executes processing corresponding to the control information while a data communication is in progress through said data processing unit.

An on-vehicle communication device according to the present invention comprises a wireless telephone means for performing wireless communications, a data processing means for engaging in data communication with an external apparatus via said wireless telephone means, a voice processing means for receiving a speech of a passenger through a microphone to allow a telephone conversation to be conducted with an outside via said wireless telephone means and to recognize the speech of the passenger input through the microphone and convert the speech to control information and a control means for engaging said voice processing means to recognize the speech input through said the and to convert the speech to control information and executes processing corresponding to the control information while a data communication is in progress through said data processing means.

An on-vehicle communication device according to the present invention comprises a connection means for connecting with a wireless telephone unit to perform wireless communication, a data processing means for engaging in data communication with an external apparatus via the wireless telephone unit, a voice processing means for receiving a speech of a passenger through a microphone to allow a telephone conversation to be conducted with an outside via the wireless telephone unit and to recognize the speech of the passenger input through the microphone and convert the speech to control information and a control means for engaging said voice processing means to recognize the speech input through the microphone and to convert the speech to control information and executes processing corresponding to the control information while a data communication is in progress through said data processing means.

A method for communicating on-vehicle according to the present invention comprises engaging in data communication with an external apparatus via the wireless telephone unit as well as allowing a telephone conversation to be conducted via a wireless telephone unit by inputting a speech of a passenger through a microphone, recognizing the speech input through the microphone during the data communication so as to convert the recognized speech into control information and executing a processing corresponding the control information.

### BRIEF DESCRIPTION OF THE DRAWINGS

FIG. 1 shows the structure assumed in an on-vehicle communication device achieved in an embodiment of the present invention;

FIG. 2 presents a flowchart of the processing executed in conformance to a speech recognition processing program in the CPU of the on-vehicle communication device in the embodiment of the present invention; and

FIG. 3 shows another structure assumed in an on-vehicle communication device achieved in an embodiment of the present invention.

### DETAILED DESCRIPTION OF THE PREFERRED EMBODIMENT

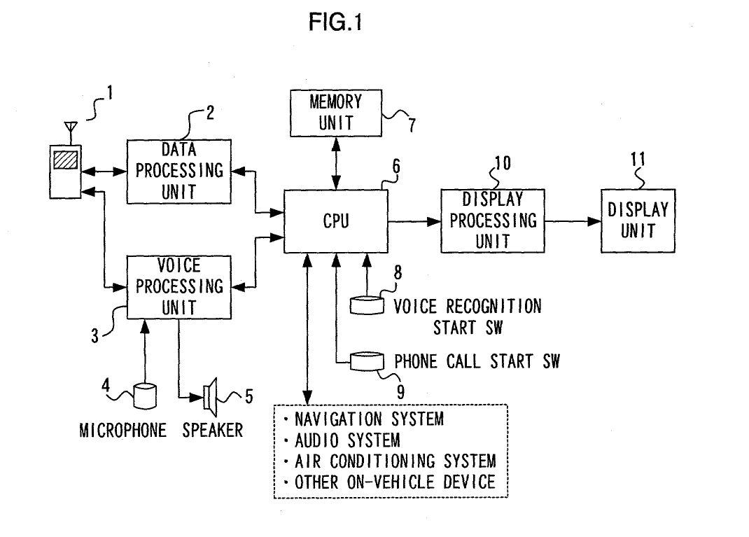

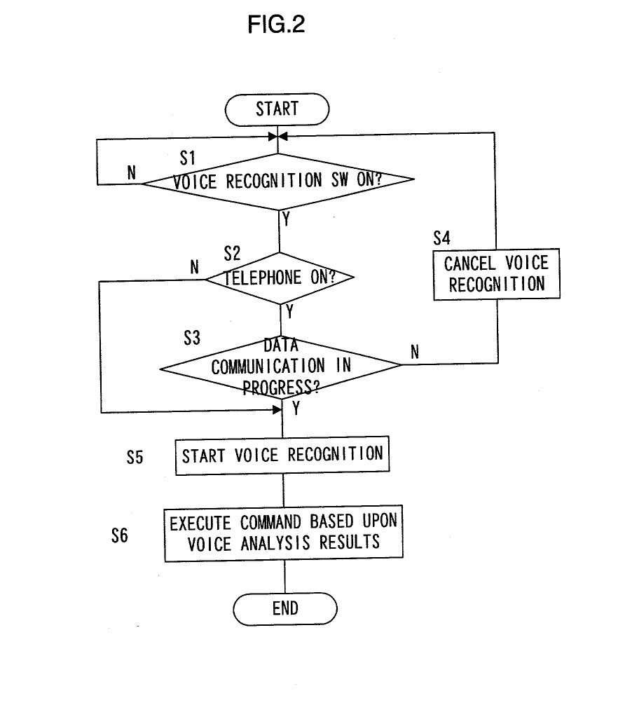

The following is an explanation of the embodiment of the present invention, given in reference to FIGS. 1 and 2.

FIG. 1 shows the structure of the on-vehicle communication device achieved in the embodiments of the present invention. A telephone call is made on a mobile telephone 1 via a public wireless telephone network. A car phone may be used instead of the mobile telephone 1. The mobile telephone is detachably connected with a data processing unit 2 and a voice processing unit 3 via a connector not shown. The data processing unit 2 engages in data communication with a host computer (not shown) via the mobile telephone 1. The data processing unit 2 transmits transmission data prepared by adding a header and the like to data to the host computer via the mobile telephone 1 and also processes data received from the host computer and outputs the processed data to a CPU 6 which is to be detailed later.

The voice processing unit 3 is connected with a microphone 4 and speaker 5 provided to enable hands-free operation. The voice processing unit 3 achieves a telephone function which enables apassenger to have a conversation with an outside party via the mobile telephone 1 by inputting his voice through the microphone 4 and a speech-recognition function whereby data are created by recognizing the voice of the passenger input through the microphone 4. Namely, the microphone 4 and the speaker 5 are utilized to enable a hands-free phone conversation on the mobile telephone 1 via the public wireless telephone network. When the microphone 4 and the speaker 5 are utilized for hands-free speech-recognition, on the other hand, voice input through the microphone 4 is converted to data and the resulting data are output to the CPU 6.

Then, the CPU 6 selects a voice command that matches the characteristics of the input voice among voice commands stored in advance at a memory unit 7 and executes processing which corresponds to the voice command. This voice command may relate to an operation of the communication terminal or it may relate to an operation of an on-vehicle electrical device connected to a communication line. It is to be noted that such an on-vehicle electrical device connected to the CPU 6 via the communication line may be a navigation system, an audio system, an air-conditioning system or the like, as shown in FIG. 1.

The CPU 6 implements control on telephone calls on the mobile telephone 1 and also implements control on data communication with the host computer implemented via the mobile telephone 1. The CPU 6 has communication state flags that indicate that a telephone call is in progress and that a data communication is in progress stored at the memory unit 7. It sets a call in progress flag during a telephone conversation and sets a data communication in progress flag during data communication.

A speech-recognition start switch 8 and a call start switch 9 and are connected to the CPU 6. The speech-recognition start switch 8 is operated to start speech-recognition, and the CPU 6 starts processing for recognizing voice input through the microphone 4 as the switch 8 is turned on. The call start switch 9, on the other hand, is a switch operated to start a call on a public phone line. A display processing unit 10 can display a voice command input through the speech-recognition, information input from the host computer and the like at the display unit 11.

It is to be noted that all the components except for the mobile telephone 1 are already provided on the vehicle and the device may be an independent (standalone) communication terminal device or it may be included in a navigation system.

FIG. 2 presents a flowchart of the processing executed in conformance to a speech-recognition processing program in the CPU 6 of the on-vehicle communication device according to the present invention. This processing program, which is stored in the memory unit 7, is executed by the CPU 6 in response to an operation of the speech-recognition start switch 8.

In step S1, it is judged as to whether or not the speech-recognition start switch 8 has been turned on. If an affirmative judgement is made that of the speech-recognition start switch 8 has been turned on in step S1, the operation proceeds to step S2. In step S2, a judgement is made based upon the current communication state flag at the memory unit 7 as to whether a phone conversation is in progress on the mobile telephone 1 or a data communication is in progress via the mobile telephone 1. If it is judged in step S2, that a telephone conversation or data communication is in progress, the operation proceeds to step S3. If, on the other hand, a negative judgement is made in step S2, the operation proceeds to step S5. When a telephone conversation or a data communication is in progress, it is judged in step S3 as to whether or not a data communication is in progress. If an affirmative judgement that a data communication is in progress is made in step S3, the operation proceeds to step S5. If, on the other hand, a negative judgement is made in step S3, the operation proceeds to step S4.

It is to be noted that if a negative judgement is made in step S2, i.e., if neither a telephone conversation or a data communication is in progress when the speech-recognition start operation is performed, the microphone 4 and the speaker 5 can be utilized for speech-recognition. Accordingly, the operation proceeds to step S5. In step S5, a speech-recognition operation is started, and thus, a speech input through the microphone 4 is converted to data at the voice processing unit 3 and a voice command matching the characteristics of the input speech is selected from the voice commands stored in advance at the memory unit 7. In the following step S6, processing is executed in conformance to the selected voice command.

If a negative judgement is made in step S3, i.e., if a telephone conversation instead of a data communication is in progress when the speech-recognition start operation is performed, the microphone 4 and the speaker 5 are utilized for a hands-free phone conversation and thus cannot be utilized for speech-recognition. Accordingly, the operation proceeds to step S4 to cancel the speech-recognition start operation and then the operation returns to step S1.

On the other hand, if an affirmative judgement is made in step S3, i.e., if a data communication is in progress when the speech-recognition start operation is performed, a regular telephone call is disabled and thus, the microphone 4 and the speaker 5 are available for hands-free speech-recognition. Accordingly, the operation proceeds to step S5. In step S5, a speech-recognition operation is started, and thus, a speech input through the microphone 4 is converted to data at the voice processing unit 3 and a voice command matching the characteristics of the input speech is selected from the voice commands stored in advance at the memory unit 7. In the following step S6, processing is executed in conformance to the selected voice command.

As described above, a speech input through the microphone while data communication is in progress is recognized and is converted to a voice command (control information) to execute processing in conformance to the voice command (control information). As a result, it becomes possible to control the on-vehicle communication device itself or an on-vehicle electrical device during the data communication with the host computer (an external apparatus) without having to provide dedicated microphones and voice processing units for telephone conversation and for speech-recognition respectively, thereby eliminating the need to wait for the completion of the data communication as required in the related art.

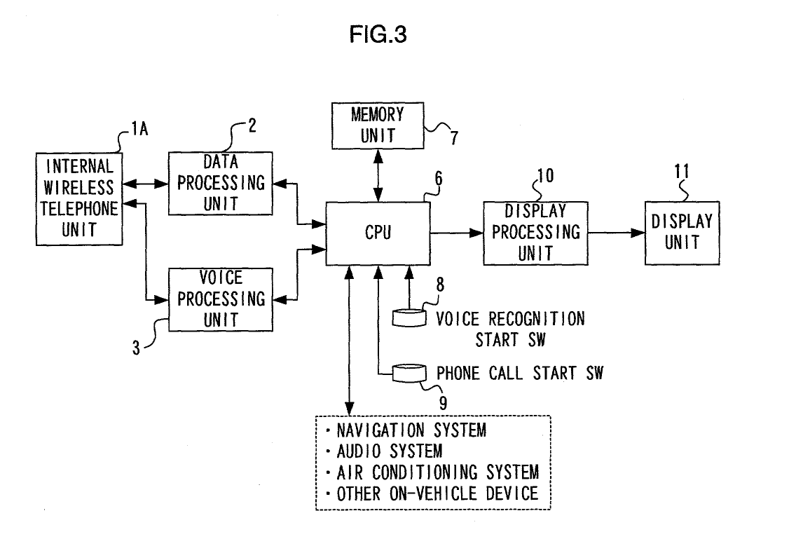

It is to be noted that while an explanation is given in reference to the embodiment on an example in which the mobile telephone 1 is externally connected to the on-vehicle communication device via the connector, a wireless telephone function (an internal wireless telephone unit) 1A may be internally provided in the on-vehicle communication device instead as shown in FIG. 3.

The above described embodiment is an example and various modifications can be made without departing from the spirit and scope of the invention.

The disclosure of the following priority application is herein incorporated by reference: Japanese patent application No. 2001-136629 filed May 7, 2001

What is claimed is;

1. An on-vehicle communication device comprising:
a wireless telephone unit that performs wireless communications;
a data processing unit that engages in data communication with an external apparatus via said wireless telephone unit;
a voice processing unit that receives a speech of a passenger through a microphone to allow a telephone conversation to be conducted with an outside via said wireless telephone unit and to recognize the speech of the passenger input through the microphone and convert the speech to control information; and
a controlling unit that engages said voice processing unit to recognize the speech input through said microphone and to convert the speech to control information and executes processing corresponding to the control information while a data communication is in progress through said data processing unit.

2. An on-vehicle communication device comprising:
a connection unit that is capable of being connected with a wireless telephone unit to perform wireless communications;
a data processing unit that engages in data communication with an external apparatus via the wireless telephone unit;
a voice processing unit that receives a speech of a passenger through a microphone to allow a telephone conversation to be conducted with an outside via the wireless telephone unit or to recognize the speech of the passenger input through the microphone and convert the speech to control information; and
a controlling unit that engages said voice processing unit to recognize the speech input through the microphone and to convert the speech to control information and executes processing corresponding to the control information while a data communication is in progress through said data processing unit.

3. An on-vehicle communication device comprising:
a wireless telephone means for performing wireless communications;
a data processing means for engaging in data communication with an external apparatus via said wireless telephone means;
a voice processing means for receiving a speech of a passenger through a microphone to allow a telephone conversation to be conducted with an outside via said wireless telephone means and to recognize the speech of the passenger input through the microphone and convert the speech to control information; and
a control means for engaging said voice processing means to recognize the speech input through the microphone and to convert the speech to control information and executes processing corresponding to the control information while a data communication is in progress through said data processing means.

4. An on-vehicle communication device comprising:
a connection means for connecting with a wireless telephone unit to perform wireless communication;
a data processing means for engaging in data communication with an external apparatus via the wireless telephone unit;
a voice processing means for receiving a speech of a passenger through a microphone to allow a telephone conversation to be conducted with an outside via the wireless telephone unit and to recognize the speech of the passenger input through the microphone and convert the speech to control information; and
a control means for engaging said voice processing means to recognize the speech input through the microphone and to convert the speech to control information and executes processing corresponding to the control information while a data communication is in progress through said data processing means.

5. A method for communicating on-vehicle comprising:
engaging in data communication with an external apparatus via the wireless telephone unit as well as allowing a telephone conversation to be conducted via a wireless telephone unit by inputting a speech of a passenger through a microphone;
recognizing the speech input through the microphone during the data communication so as to convert the recognized speech into control information; and
executing a processing corresponding the control information.

6. An on-vehicle communication device according to claim 1, wherein;
the control information includes control information with regard to an on-vehicle electrical device.

7. An on-vehicle communication device according to claim 2, wherein;
the control information includes control information with regard to an on-vehicle electrical device.
